(19) United States
(12) Patent Application Publication
(10) Pub. No.: US 2025/0113949 A1
(43) Pub. Date: Apr. 10, 2025

(54) SYSTEM AND METHOD FOR UTILITY CONTAINER WITH GRINDER

(71) Applicant: Brakr LLC, Arvada, CO (US)

(72) Inventor: ASHRAF NASHAT SAWAGED, Arvada, CO (US)

(73) Assignee: Brakr LLC, Arvada, CO (US)

(21) Appl. No.: 18/904,317

(22) Filed: Oct. 2, 2024

Related U.S. Application Data
(60) Provisional application No. 63/543,244, filed on Oct. 9, 2023.

(51) Int. Cl. A47J 42/34; A47J 42/40

(52) U.S. Cl. CPC A47J 42/34; A47J 42/40

(57) ABSTRACT

Provided are a system and method for a utility container with grinder (“UCWG”). In general, the UCWG includes a housing providing an at least one internal storage area proximate to a first end. A grinder is provided proximate to a second end opposite from the first end, the grinder having a removable grinder cap. An internal separator separates the at least one internal storage area from the grinder. The first end has a lid structured and arranged to temporarily seal the at least one internal storage area, the lid having an external depression structured and arranged to hold a known volume of ground material. The removable grinder cap structured and arranged to be disposed within the housing below the lid. An associated method of use is also provided.

### CROSS REFERENCE TO RELATED APPLICATIONS

This application claims the benefit under 34 U.S.C. § 119(e) of U.S. Provisional Application No. 63/543,244 filed Oct. 9, 2023 and entitled SYSTEM AND METHOD FOR SMOKER'S UTILITY CONTAINER, the disclosure of which is incorporated herein by reference.

### FIELD OF THE INVENTION

The present invention relates generally to systems and methods for storing and grinding herbal materials. Moreover, the present invention provides a unitary device, aka container, that provides an airtight reservoir to hold and maintain one or more herb elements, and a grinder structured and arranged to grind, shred, shear or otherwise deconstruct the natural herb material into substantially uniform elements suitable for dispassion in a smoking article.

### BACKGROUND

Herbal products such as tobacco and the like, have been known and enjoyed as a smokable commodity for a long time. However, it is understood and appreciated that the smoking of the natural plant material in its original organic form as leaves, buds or other plant material in an unprocessed state is not typically the choice for most users.

Indeed, with respect to the tobacco industry, companies have invested great resources for the farming and cultivation of specific tobacco plant varieties, and subsequently the processing and refinement of the harvested tobacco plant materials in to specific blends and mixtures.

For uniform burning and consistent smoking experiences, it is not at all uncommon for the smoking material to be processed to a consistent size—in other words the leaves are chopped up, ground, sheered or otherwise processed so as to provide a uniform material that may be rolled into cigarette, cigars, or packages that may be used to fill and refill pipe bowls.

With respect to herbal smoking materials, processing of the plant material is likewise desirable so as to provide generally uniform material to be burned in the smoking experience.

For a variety of different reasons, many herbal materials that are desirable for smoking consumption are not processed at a commercial scale. Rather, it is not uncommon for a user to purchase a small quantity of herbal material in a very natural state. As an unprocessed natural material, most users take care to preserve the state of this material by keeping it in closed containers that are generally substantially air tight when sealed, so as to preserve the material until such time as it is desirable to smoke.

For the preparation of a smoking material from the herbal material, typically the herbal material must be ground. Most users, typically therefore have not only a storage container, but very likely a grinder, and may also have an additional container that can at least temporarily hold the ground materials until such time as they are disposed in rolling papers or the bowl of a pipe.

But with a storage container, a grinder, and perhaps a grounds storage container, this quickly results in the user having a plurality of different containers that he or she must keep track of. It is also likely that these distinct containers and systems may need cleaning, or at least replacement after some period of use. Certainly, simple disposal increases waste in landfills as well as cost in the acquisition of new containers.

Often times these separate containers and devices are somewhat cumbersome and do not fit neatly into a user's pocket or purse.

These issues have been realized and addressed somewhat by others. For example, U.S. Pat. No. 8,695,906 to Hainbach teaches a Combination Herb Storage, Grinder and Pouring Container. The Hainbach container 10 is comprised of a cap 12 which attaches to a base cup 14 that has grinding elements in the form of teeth 44 oriented upward towards the interior of the base cup 14. Within the base cup 14 is a storage receptacle 16 has an inner container space 22 that fits within a base cup 14, the storage receptacle 16 having external teeth 26 which are structured and arranged to engage with teeth 44 on the inside of the base cup 14. But it is noted that there is only one cap 12 sealing the entire container, and that the grinding element is disposed at the inside bottom of the container which may pose a challenge to full and complete cleaning. When the cap 12 is removed, there appears no mechanism other than friction to hold the storage receptacle 16 in place with the base cup 14, which obviously could permit spillage of ground herb. Moreover, cap 12 cannot engage and seal the storage receptacle 16—the cap 12 engages with the base cup 14, and collectively the cap 12 and base cup 14 enclose the receptacle 16.

Another option is presented by U.S. Pat. No. 9,730,554 to Chan teaching a Device And Method For Airtight Storage And Grinding of Herbs. In Chan, the storage device 100 provides a compartment 102 for storing herbs, and a detachable lids 112 and 124 which once removed may be joined to form a grinder element. However once detachable lid 112 is removed for combination with lid 124, the container compartment 102 remains open and unsealed, such that any stored herbs could accidently fall out. It is also to be noted that as the detachable lids are indeed completely detachable, it is possible for one or both to be knocked loose, dropped, and/or misplaced. Chan also fails to provide any option for storing ground material and unground material separately.

Yet another option is presented by U.S. Pat. No. 11,019,962 to Kirk teaching a Container Apparatus. As with Chan, Kirk teaches a container apparatus 100 including a container body 105 and a container lid 110 having a bottom member 115 and a top member 120. This lid 110 may function as a grinder as the two members have a plurality of internal teeth structured and arranged to grind herb material disposed therebetween. Once again, as the container lid 110 is entirely removable, and indeed the bottom member 115 and top member 120 are also distinct and separate components, there is a chance one or more of these items may be knocked loose, dropped, and/or misplaced.

Hence there is a need for a method and system that is capable of overcoming one or more of the above identified challenges.

### SUMMARY OF THE INVENTION

Our invention solves the problems of the prior art by providing novel systems and methods for a utility container with grinder.

In particular, and by way of example only, according to at least one embodiment, provided is a utility container with grinder, including: a housing providing an at least one internal storage area proximate to a first end; a grinder proximate to a second end opposite from the first end, the grinder having a removable grinder cap; an internal separator separating the at least one internal storage area from the grinder; and the first end further having a lid structured and arranged to temporarily seal the internal unprocessed material storage area, the lid having an external depression structured and arranged to hold a known volume of ground material, the removable grinder cap structured and arranged to be disposed within the housing below the lid.

For yet another embodiment, provided is a utility container with grinder, including: a housing providing an at least one internal storage area proximate to a first end; a lid structured and arranged to temporarily seal at least one internal storage area, the lid having an external depression structured and arranged to hold a known volume of ground material; a first grinder element proximate to a second end opposite from the first end, the first grinder element providing first grinding structures extending from the second end; a second grinder element providing second grinding structures encircled by a circumferential wall, the second grinder element structured and arranged to in a first instance nest within the at least one internal storage area adjacent to the lid, and in a second instance to removably engage with the first grinder element for the grinding of unprocessed material placed therebetween; and an internal separator separating the at least one internal storage area from the first grinder element.

And for still yet another embodiment, provided is a method of using a utility container with grinder, including: providing a housing providing an at least one internal storage area proximate to a first end; providing a lid structured and arranged to temporarily seal the at least one internal storage area, the lid having an external depression structured and arranged to hold a known volume of ground material; providing a first grinder element proximate to a second end opposite from the first end, the first grinder element providing grinding elements generally normal to the second end; providing a second grinder element providing second grinding structures encircled by a circumferential wall, the second grinder element structured and arranged to in a first instance nest within the at least one internal storage area adjacent to the lid, and in a second instance to removably engage with the first grinder element for the grinding of unprocessed material placed therebetween; providing an internal separator separating the at least one internal storage area from the first grinder element; and wherein a user removes unprocessed material from the at least one internal storage area and deposits at least a portion of the removed unprocessed material in the second grinder element, the user disposing the second grinder element upon the first grinder element to grind the removed unprocessed material into ground material, the user using the external depression of the lid to measure a predetermined quantity of the ground material, the user storing any additional ground material with the second grinder element within the housing.

### BRIEF DESCRIPTION OF THE DRAWINGS

FIG. 1A is a top perspective of a Utility Container With Grinder (“UCWG”) according to at least one embodiment of the present invention;

FIG. 1B is a top perspective of a UCWG according to at least one alternative embodiment of the present invention;

FIGS. 2A and 2B are side cut through views of UCWG shown in FIG. 1A, according to at least one embodiment of the present invention;

FIGS. 2C and 2D are side cut through views of UCWG shown in FIG. 1B, according to at least one embodiment of the present invention;

FIGS. 3A and 3B are corresponding top and bottom perspective views of a UCWG according to at least one embodiment of the present invention;

FIG. 4 is an enlarged top perspective view of a grinder cap of an UCWG according to at least one embodiment of the present invention;

FIGS. 5A and 5B are side cut through views of an UCWG in use according to at least one embodiment of the present invention; and

FIG. 6 is a flow diagram illustrating a method of providing and using an UCWG according to at least one embodiment of the present invention;

### DETAILED DESCRIPTION

Before proceeding with the detailed description, it is to be appreciated that the present teaching is by way of example only, not by limitation. The concepts herein are not limited to use or application with a specific system or method for utility container with grinder. Thus, although the instrumentalities described herein are for the convenience of explanation shown and described with respect to exemplary embodiments, it will be understood and appreciated that the principles herein may be applied equally in other types of systems and methods involving a utility container with grinder providing multiple functions for smokers.

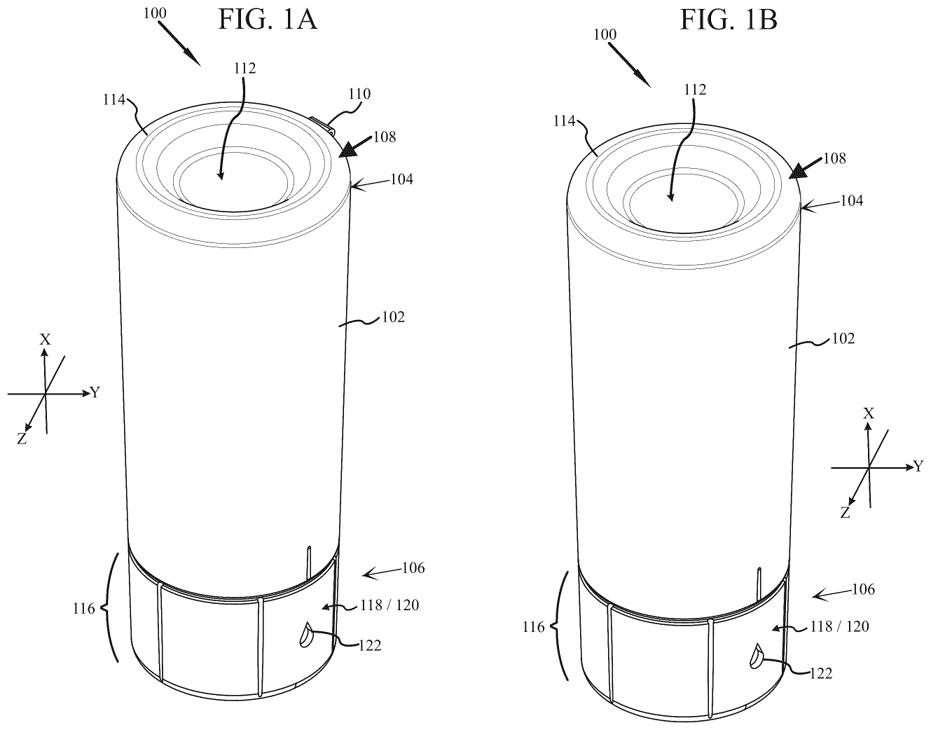

This invention is described with respect to preferred embodiments in the following description with reference to the Figures, in which like numbers represent the same or similar elements. Further, with respect to the numbering of the same or similar elements, it will be appreciated that the leading values identify the Figure in which the element is first identified and described, e.g., element 100 first appears in FIG. 1.

Turning now to FIGS. 1A and 1B, there is shown a perspective view from above of a utility container with grinder 100, hereinafter “UCWG 100”, in accordance with at least one embodiment of the present invention.

It will be appreciated that for at least one embodiment, UCWG 100 is structured and arranged to carry and store unprocessed material in a sealable storage area of the UCWG 100, and to grind and otherwise prepare a portion of the stored material (once removed from the storage area) in a compact portable grinder that is affixed to the UCWG 100 opposite from the storage area.

To facilitate the description of systems and methods for embodiments of UCWG 100, the orientation of UCWG 100 as presented in the figures is referenced to the coordinate system with three axes orthogonal to one another as shown in FIG. 1. The axes intersect mutually at the origin of the coordinate system, which is chosen to be the center of UCWG 100, however the axes shown in all figures are offset from their actual locations for clarity and ease of illustration.

As this is an exterior perspective view, the UCWG 100 may be appreciated as being a very simple, sleek and unobtrusive device. For at least the embodiment shown, UCWG 100 is provided at least in part by a housing 102, having a first end 104 and a second end 106.

A lid 108 is shown engaged to the first end 104, and provides access to the storage chamber(s) within the housing 102, suitable for the storage of herb materials. It will be further understood and appreciated that with the cap engaged to the housing 102, the internal storage area is water tight. It will be understood and appreciated that lid 108 may also be referred to as a “cap”, however for ease of discussion and illustration, the term “lid” will be used for this element so as not to be confused with the “grinder cap” which will be discussed below.

For the embodiment shown in FIG. 1A, the lid 108 is hingidly attached to the housing 102 by hinge 110. In other words, the lid 108 may be flipped up from a closed/sealed position engaged with the first end 104, but remains attached to the container by a hinge 110, provided by flexible band of material or other appropriate structure.

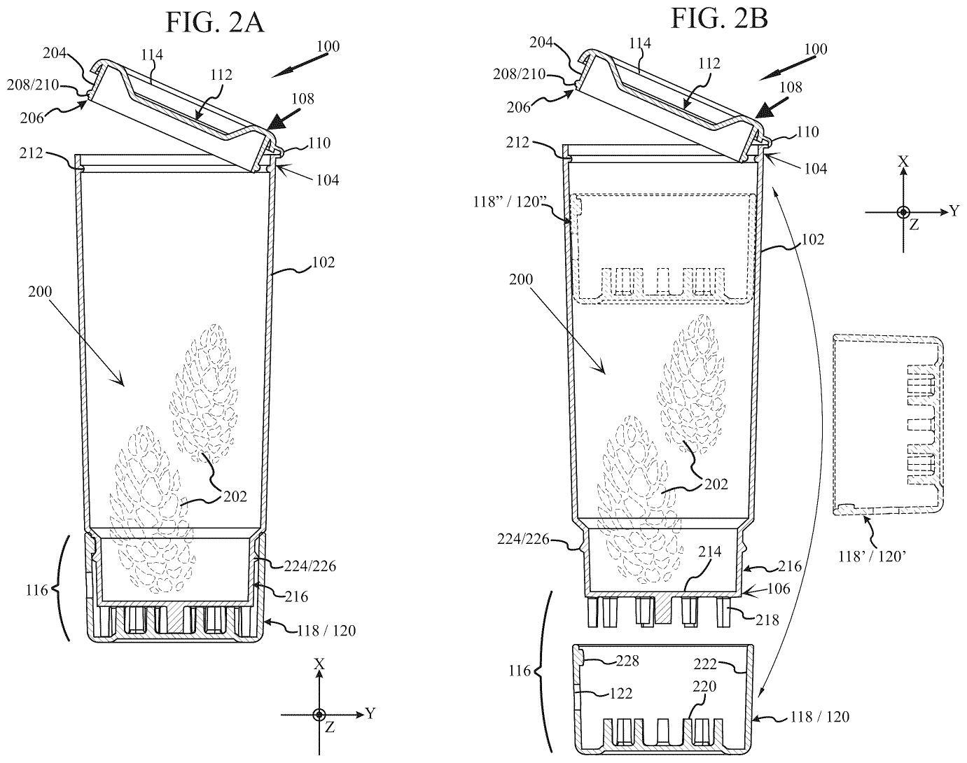

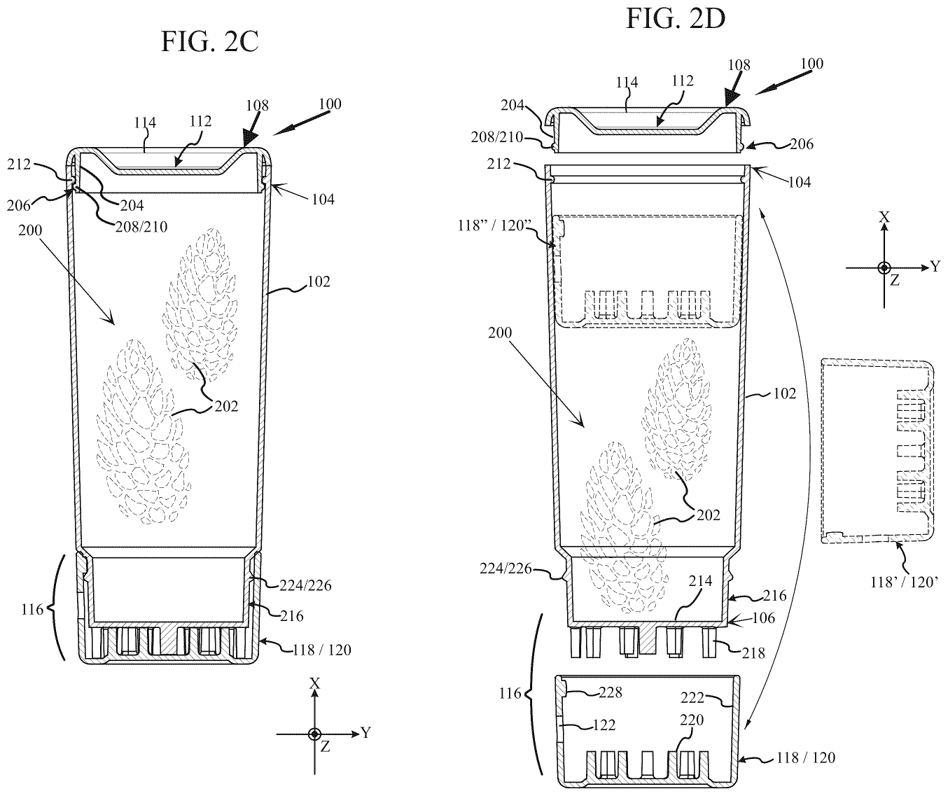

It will also be understood that for yet another alternative embodiment, the hinge 110 may be replaced by a strap (not shown), providing a linking connection between the lid 108 and the housing 102. Moreover, for at least one embodiment the hinge may also be considered as a strap, sufficient to permit the removal of the lid 108 from the housing 102, such that the lid 108 may hand along the side of the housing 102, but is otherwise not easily dropped, lost or forgotten as it remains tethered to the housing 102 when removed to allow access to the at least one internal storage area (see FIGS. 2, 3, 4 and 5).

For the embodiment shown in FIG. 1B, the lid is not physically attached to the housing.

For at least one embodiment, the lid 108 will be understood and appreciated to be a child-resistant lid, such as but not limited to a push-and-turn type of lid, squeeze-and-turn type of lid, rim-snap/rim-lever type of lid, or other variations thereof as are commonly affixed to prescription pill bottles. Push-and-turn caps are understood and appreciated to require the operator to push down on the lid while turning it to unscrew it, squeeze-and-turn lid are understood and appreciated to require the operator to squeeze the sides of the lid inward while turning to unscrew it, and rim-snap/rim lever caps have an element extending to one side that must be bent down and away from the lid so that it may be unscrewed.

It may also be appreciated that the lid 108 has an external depression 112 that is structured and arranged to hold a known volume of ground herb. Indeed for at least one embodiment, the depression 112 in the lid 108 has volume indicators 114 so that a user may appreciate one or more known volumes of the ground material that has been deposited in the lid 108. It will be understood and appreciated that the volume indicators 114 may be provided as visual indicia (lines, partial lines, or other visual elements, etc. . . . ) as well as tactical indicia (bumps, ridges, depressions, etc) to assist the visually impaired.

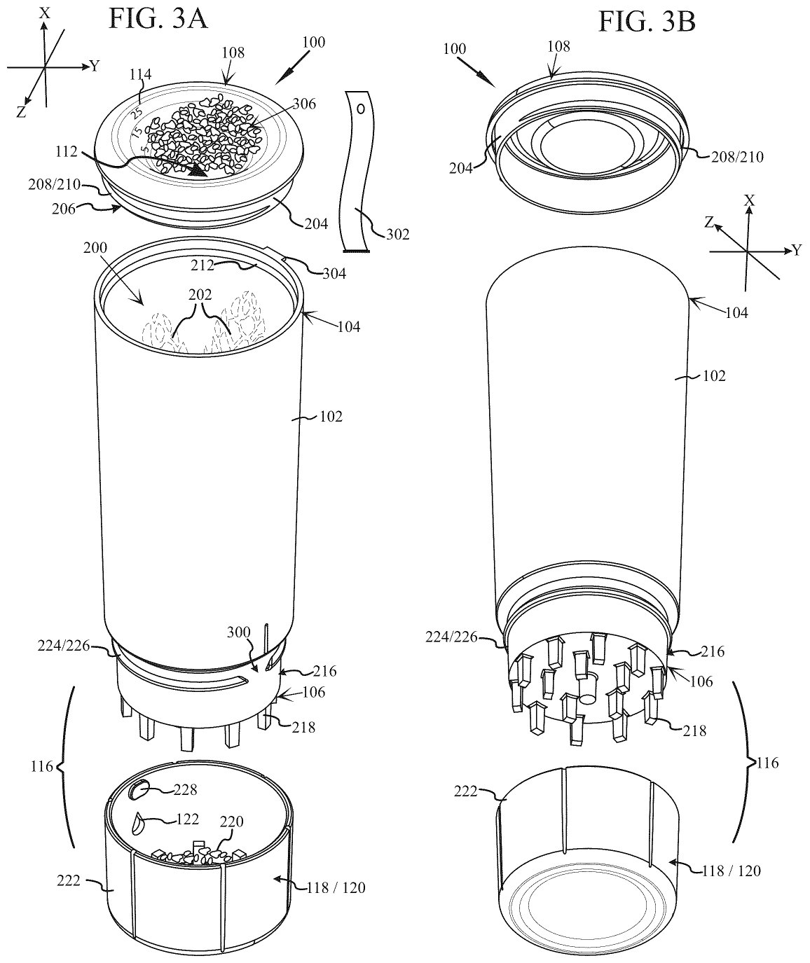

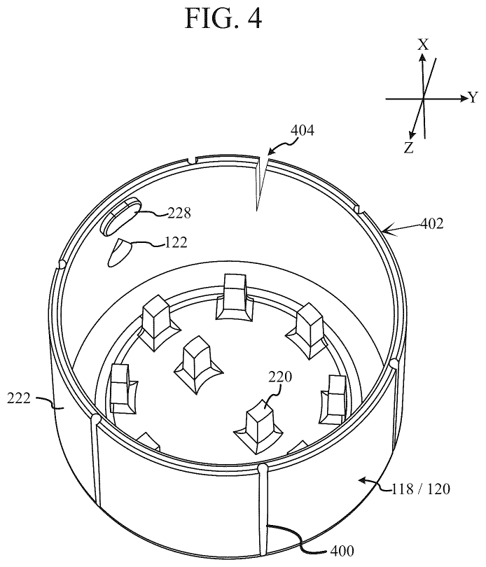

UCWG 100 also provides a grinder 116 proximate to the second end 106. The grinder 116 is provided by a combination of elements—a first grinder element (not shown in FIG. 1) that is a component of the housing 102 at the second end 106 and a second grinder element 118, e.g., cap 120, which also may be referred to as a grinder cap, grinding cap, grinding wheel, or the like as it is rotated by a user's hand about the central axis of the housing 102/UCWG 100. In FIG. 1, the first grinder element is substantially shielded from view by the second grinder element 118, e.g., cap 120, but the first grinder element is shown and described with respect to FIGS. 2 and 3 discussed below.

It will also be appreciated that in both FIGS. 1A and 1B, the second grinder element 118, e.g., cap 120, has a side aperture 122, that will be more fully discussed and described below.

FIGS. 2A and 2B provide side cut through views of the UCWG 100 shown in FIG. 1A (lid 108 hingidly attached)—FIG. 2A in assembled form, and FIG. 2B is partially exploded form—now showing at least one internal storage area 200. As FIG. 2B is in partially exploded form, for ease of illustration and discussion, more elements have been identified in FIG. 2B, than in FIG. 2A.

Similarly, FIGS. 2C and 2D provide side cut through views of the UCWG 100 shown in FIG. 1B (lid 108 not hingidly attached)—FIG. 2C in assembled form, and FIG. 2D is partially exploded form—now showing at least one internal storage area 200. As FIG. 2D is in partially exploded form, for ease of illustration and discussion, more elements have been identified in FIG. 2D, than in FIG. 2A. C

In addition, as is further discussed below, FIGS. 2B and 2D conceptually illustrates that the second grinder element 118, e.g., the cap 120 (collectively identified as element 118/120) transitions from being proximate to the first grinder element 216, through an intermediary position shown in dotted relief as 118′/120′ to a storage position within the housing 102, and more specifically the at least one internal storage area 200, shown in second dotted relief 118″/120″.

It is also to be appreciated that the at least one internal storage area 200 is structured and arranged to be large enough to accommodate storage of unprocessed material 202 (“herbs”) or other raw materials prior to grinding.

Although the at least one internal storage area 200 is shown as a single space, for at least one alternative embodiment, the at least one internal storage area 200 maybe subdivided into a plurality of different storage areas, such as a first primary storage area for unprocessed materials and a second primary storage area for rolling papers or the like.

In these views it may be appreciated that the lid 108 does indeed seal the at least one internal storage area 200. For at least one embodiment, this temporary sealing of the at least one internal storage area 200 is achieve at least in part by the lid 108 having a circumferential ridge 204 extending away from the outer depression 112 towards the at least one internal storage area 200, this circumferential ridge 204 having a first binder 206 structured and arranged to bind with an inner portion of the housing 102 proximate to the first end 104.

For at least one embodiment, this first binder 206 is a distal edge 208, which may be a flexible ridge 210 that is structured and arranged to engaged with a second flexible ridge 212 disposed about the inside of the housing 102 proximate to the first end.

For yet another embodiment, this first binder 206 may be a distal edge 208, which may be a flexible ridge 210 that is structured and arranged to engage with a circumferential groove disposed about the inside of the housing 102 proximate to the first end 104. It will be understood and appreciated that for at least one alternative embodiment, the placement of the flexible ridge and groove may be reversed. More specifically, for at least one alternative embodiment (not shown), the lid 108 may provide a circumferential groove about the circumferential ridge proximate to the distal edge 208 and the housing may provide a corresponding flexible ridge proximate to the first end 104.

As shown in FIGS. 2A-2D, there is also an internal separator 214 between the at least one internal storage area 200 and the grinder 116. The internal separator 214 may also be referred to as the inside bottom of the at least one storage area 200. Most specifically, it will be understood and appreciated that internal separator 214 (aka bottom) is solid, such that when the lid 108 is engaged upon the housing 102, the at least one internal storage area 200 is sealed, and for at least one embodiment, water tight.

In other words, it will be understood and appreciated that the UCWG 100 is not akin to a pepper grinder type of device where items, such as peppercorns stored in an internal storage are pass directly from the storage area through a grinder element to be deposited as ground material external to the pepper grinder.

The grinder 116, noted above with respect to FIGS. 1A and 1B, may now be more fully appreciated with respect to FIGS. 2A-2D. The first grinder element 216 may now be appreciated as a component of the bottom of the housing 102.

The first grinder element 216, has a plurality of first grinding structures 218. Similarly, the second grinder element 118, e.g., the grinder cap 120, has a plurality of second grinding structures 220 encircled by a circumferential wall 222. It will be understood and appreciated that the first grinder element 216 and the second grinder element 118 collectively couple and interact to provide a substantially sealed grinder 116, having a circumferential wall. Although the circumferential wall has been shown for the present embodiments as a component of the second grinder element 118, for yet another embodiment the plurality of first grinding structures 218 may also be encircled by a circumferential wall circumferential wall that is a component of the first grinder element. Further still, for yet another optional embodiment, both the first grinder element and 216 the second grinder element 118 may each provide a circumferential wall which may either nest together or otherwise cooperatively combine.

The first grinding structures 218 and the second grinding structures 220 are predisposed to align and pass between each other such that when the second grinder element 118, e.g., the grinder cap 120, is disposed about the first grinder element 216 and second grinder element 118 is rotated relative to the housing 102, the first grinding structures 218 and the second grinding structures 220 cooperatively interact to grind, and/or shred herbs or other grindable materials disposed within the assembled grinder 116.

For at least one embodiment the first grinder element 216 and the second grinder element 118 collectively provide a burr grinder.

For at least one embodiment, the first grinding structures 218 and the second grinding structures 220 are substantially rectangular structures, which by themselves are not substantially sharp and are therefore unlike to cut an operator's hand or damage clothing, pockets, purses, backpacks or other objects that may come in contact with first grinding structures 218 and the second grinding structures 220.

However, it will be understood and appreciated that the first grinding structures 218 and the second grinding structures 220 are formed from materials having sufficient density and/or resistance that they are hard enough/tough enough, to grind/crush/cut/chop herbs or other grindable materials that are disposed between the first grinder element 216 and the second grinder element 118, e.g., the grinder cap 120.

For yet another embodiment, at least some of first grinding structures 218 and the second grinding structures 220 are indeed sharp and thereby actively cut the herbs or other grindable materials that are disposed between the first grinder element 216 and the second grinder element 118, e.g., the grinder cap 120, as part of the grinding process.

With respect to FIGS. 2A-2D, it may be appreciated that the second grinder element 118, e.g., the grinder cap 120, has a circumferential wall 222 that is structured and arranged to fit about a lower portion of the housing 102 that is the base for the first grinder element 216. For this embodiment, this lower portion of the housing 102 provides a second binder 224 that is structured and arranged to bind with an inner portion of the circumferential wall 222 of the second grinder element 118.

For at least one embodiment, this second binder 224 is a ridge 226 disposed about the lower portion of the housing 102 that is structured and arranged to engaged with a ridge 228 disposed upon the inside of the circumferential wall 222—ridge 226 having a gap through which ridge 228 may pass as the grinder cap 120 is attached to the lower portion of the housing.

The second binder 224 may be more fully appreciated with respect to FIG. 3A showing an exploded upper perspective view of UCWG 100. As is shown, the ridge 228 upon the inside of the circumferential wall 222 is actually a short element passing through the gap 300 in the ridge 226 about the lower portion of the housing 102.

As with the first binder 206 discussed above, in various alternative embodiments, the second binder 224 may be provided by a circumferential ridge on the housing 102, and a groove disposed within the inner surface of the circumferential wall 222, or in the alterative, the housing 102 may provide the groove and the inner surface of the circumferential wall 222 may provide the ridge.

As the second grinder element 118 is intended to be rotated relative to the housing 102, it will be appreciated that the second binder 224 as provided by varying combinations of ridges and grooves is structured and arranged to facilitate easy turning between the engaged parts by a user.

Although the second grinder element 118, e.g., the grinder cap 120, can be left in attachment with the housing 102, an advantageous feature of the UCWG 100 is that the second grinder element 118, e.g., the grinder cap 120, is also structured and arranged to be stored within the housing 102 below the lid 108 and above the least one internal storage area 200. Moreover, the second grinder element 118 is structured and arranged to nest within the at least one internal storage area 200.

This removability and internal storage of the second grinder element 118, e.g., the grinder cap 120, will be appreciated as advantageous for several reasons. By storing the second grinder element 118, e.g., the grinder cap 120, within the housing 102, there is significantly less chance that the second grinder element 118, e.g., the grinder cap 120, may be knocked off and lost by accident.

Further, as the first grinder element 216 is left open and exposed when the second grinder element 118, e.g., the grinder cap 120, is removed for storage, the first grinder element 216 is permitted to dry out and will remain cleaner between uses to grind herbs. Further still, when disposed within the container, the first grinder element 216 provides a secondary storage area which may be used to store ground herbs separate from the unprocessed material 202 or other raw materials in the primary storage area 200.

In FIGS. 2B and 2D, it will also be appreciated that the grinder cap 120 has a lateral side aperture 122, which is advantageously structured and arranged as a cutter/stripper. More specifically, a portion of the herb (stock or branch with leaves) may be at least partially disposed within this side aperture 122 (inserted from the inside) and then pulled across the groove to advantageously separate the leaf material from the stock or branch—this removed leaf material also conveniently left within the grinder cap 120/which is ready for temporary attachment to the housing 102 so as to engage with the first grinder element 216. For at least one embodiment, this side aperture 122 is also structured and arranged to cut paper.

As noted above, FIG. 3A is an upper perspective exploded view of UCWG 100 in accordance with at least one embodiment, and FIG. 3B is a corresponding lower perspective exploded view of UCWG 100 in accordance with at least one embodiment.

With respect to FIG. 3A, the gap 300 in the second binder 224 may now be more fully appreciated. In addition, the first binder 206 may be more fully appreciated in an optional embodiment where the ridge 210 on the lid 108 is provided as screw threads. Accordingly for this optional embodiment the lid 108 is screwed on and off of the housing 102. The hinge has also been illustrated as comprising a strap element 302 which may be attached to a hinge base 304 on the housing 102 and attached to the external depression 112 so as to permit the lid 108 to be attached to the housing 102 while remaining free to rotate when screwed on or off.

It will also be appreciated that this alternate embodiment of the lid 108 with a screw based first binder 206 may be further adapted as a child-resistant lid 108 incorporating a child-resistant lid, such as but not limited to a push-and-turn type of lid, squeeze-and-turn type of lid, rim-snap/rim-lever type of lid, or other variations thereof as are commonly affixed to prescription pill bottles.

In FIG. 3A, ground material 306 has been added in the external depression 112 to further illustrate the advantageous use of the volume indicators, three of which are shown as conceptual volumes “5” “15” and “25”.

In FIG. 3B, the first grinding structures 218 may be more fully appreciated.

FIG. 4 is an enlarged top perspective view into the second grinder element, e.g., the grinder cap 120. In FIG. 4, the second grinding structures 220 may be more fully appreciated. In addition, a plurality of vertical side grooves 400 are shown which may be provided in at least one embodiment to facilitate the user in grasping the grinder cap 120 and rotating it in relation to the housing 102.

It will also be appreciated that the circumferential wall 222 has a distal edge 402. For at least one embodiment, a cuter groove 404 is disposed within the circumferential wall 222 extending downward from the distal edge, this cutter groove 404 is structured and arranged to cut material such as paper. Of course, it will be understood and appreciated that cutter groove 404 may be disposed in a different location, or even a different element of UCWG 100. For yet another embodiment, the cutter groove 404 may be incorporated as a component of the side aperture 122.

With respect to FIGS. 3B and 4 and the depiction of first grinding structures 218 and second grinding structures 220, they are the peg/block like structures discussed above, structured and arranged to cooperatively interact to crush and grind the desired material without presenting significantly sharp cutting edges. Of course, for yet an alternative embodiment, one or more of either or both of the first grinding structures and the second grinding structures may be fashioned and provided as cutting blades.

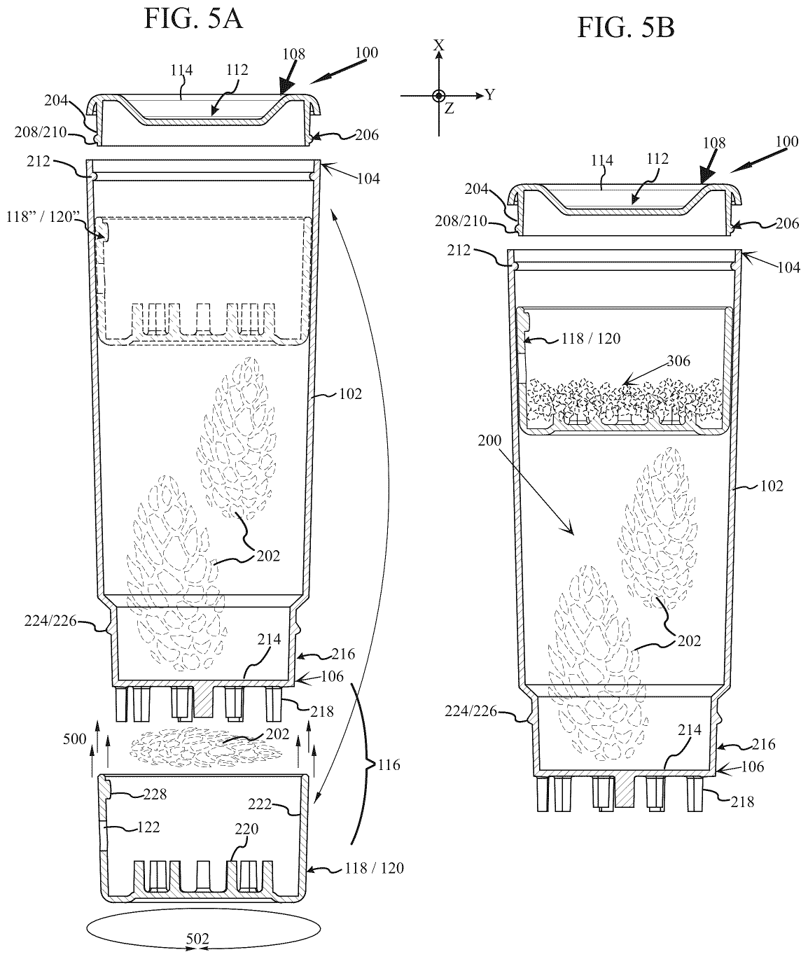

FIGS. 5A and 5B illustrate side cut through views of UCWG 100 first in perpetration for use in the grinding of unprocessed material 202 (FIG. 5A), and then in a configuration for storage of ground material 306 (FIG. 5B).

In FIG. 5A, the second grinder unit 118, e.g., grinder cap 120 has been removed from its storage location within the at least one internal storage area 200, and disposed proximate to the first grinder element 216. As shown, some unprocessed material 202 has been disposed between the first grinder element 216 and the second grinder element 118. First grinder element 216 and the second grinder element 118 are then brought together as indicated by arrows 500, and the second grinder element 118 is rotated relative to the housing 102 as indicated by arrows 502.

When the user has rendered a desired amount of ground material 306, the second grinder element, e.g., grinder cap 120 may be disposed within the at least one internal storage area until the use of such ground material 306 is desired, as shown in FIG. 5B. Moreover, it will be understood and appreciated that UCWG 100 advantageously provides the ability to store ground and unground materials separately within the housing 102. For at least one embodiment, when the grinder cap 120 is disposed within the housing 102, the grinder cap 120 establishes an air tight seal, if not water tight seal/moisture tight seal, within the housing 102 above the internal storage area 200 in which the unground/unprocessed material 202 is stored.

It will be understood and appreciated that in varying embodiments, the UCWG 100 and its components may be made of durable materials, such as but not limited to plastics (including bpa free plastic), aluminum/stainless steel or other metals, ceramic, composite materials, fiber glass, fiber resin, rubber, etc. . . . Moreover, the UCWG 100 may be fabricated from materials that are deemed most suitable for the embodiment desired.

Moreover, for at least one embodiment, the UCWG 100 may be summarized as including: a housing 102 providing an at least one internal storage area 200 proximate to a first end 104; a grinder 116 proximate to a second end 106 opposite from the first end 104, the grinder 116 having a removable grinder cap 120; an internal separator separating the at least one internal storage area 200 from the grinder 116; and the first end 104 further having a lid 108 structured and arranged to temporarily seal the at least one internal storage area 200, the lid 108 having an external depression 112 structured and arranged to hold a known volume of ground material, the removable grinder cap 120 structured and arranged to be disposed within the housing 102 below the lid 108.

For yet another embodiment, the UCWG 100 may be summarized as including: a housing 102 providing an at least one internal storage area 200 proximate to a first end 104; a lid 108 structured and arranged to temporarily seal the at least one internal storage area 200, the lid 108 having an external depression 112 structured and arranged to hold a known volume of ground material; a first grinder element 216 proximate to a second end 106 opposite from the first end 104, the first grinder element 216 providing first grinding structures 218 extending from the second end 106; a second grinder element 118 providing second grinding structures 220 encircled by a circumferential wall 222, the second grinder element 118 structured and arranged to in a first instance nest within the at least one internal storage area 200 adjacent to the lid 108, and in a second instance to removably engage with the first grinder element 216 for the grinding of unprocessed material 202 placed therebetween; and an internal separator 214 separating the at least one internal storage area 200 from the first grinder element 216.

Having described various physical embodiments of the present invention, it will also be understood and appreciated that the present invention relates to a method of using a UCWG 100. It will be appreciated that the described methods need not be performed in the order in which they are herein described, but that these descriptions are merely exemplary of methods to provide and use a UCWG 100.

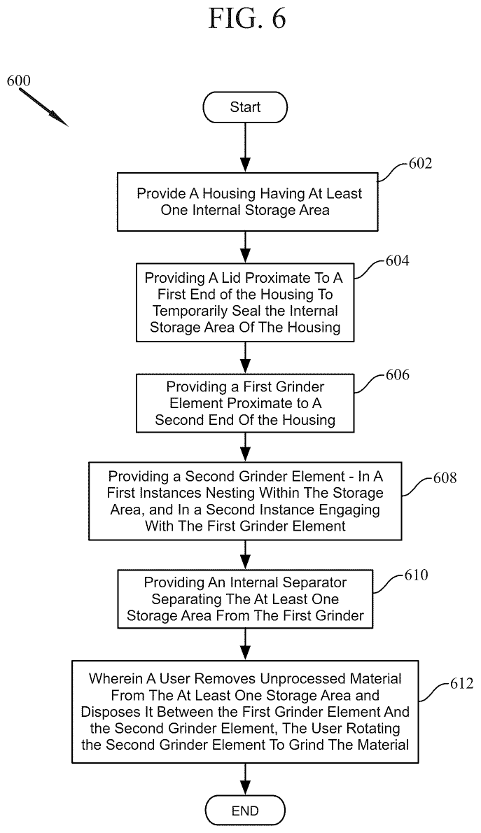

Turning now to FIG. 6 presented is a flow diagram for at least one method 600 of providing a and using UCWG 100. Method 600 may be further understood and appreciated with reference to FIGS. 1 through FIG. 5B as discussed above. In general, method 600 commences with providing a housing 102 having at least one internal storage area 200, block 602

The method 600 continues with providing a lid 108 proximate to a first end 104 of the housing 102 to temporarily seal the at least one internal storage area 200, block 604,

The method 600 continues with providing a first grinder element 216 proximate to a second end 106 of the housing 102, the second end 106 opposite from the first end 104, block 606.

The method 600 continues with providing a second grinder element 118, the second grinder element 118 structured and arranged to, in a first instance, nest within the at least one storage area 200, and in a second instance engage with the first grinder element 216, block 608.

The method 600 continues with providing an internal separator 214 separating the at least one internal storage space 200 from the first grinder element 216, block 610.

With the UCWG 100 thus provided, the method 600 continues as a method of use, wherein a user removes some unprocessed material 202 from the at least one internal storage area 200 and disposes this removed material between the first grinder element 216 and the second grinder element 118 and then with the second grinder element 118 engaged with the first grinder element 216, the user rotates the second grinder element 118 relative to the housing to grind the unprocessed material 202, block 612.

Moreover, method 600 may be summarized as providing a housing 102 providing an at least one internal storage area 200 proximate to a first end 104; providing a lid 108 structured and arranged to temporarily seal the at least one internal storage area 200, the lid 108 having an external depression 112 structured and arranged to hold a known volume of ground material; providing a first grinder element 216 proximate to a second end 106 opposite from the first end 104, the first grinder element 216 providing grinding elements generally normal to the second end 106; providing a second grinder element 118 providing second grinding structures 220 encircled by a circumferential wall 222, the second grinder element 118 structured and arranged to in a first instance nest within the at least one internal storage area 200 adjacent to the lid 108, and in a second instance to removably engage with the first grinder element 216 for the grinding of unprocessed material 202 placed therebetween; providing an internal separator 214 separating the at least one internal storage area 200 from the first grinder element 216; and wherein a user removes unprocessed material 202 from the at least one internal storage area 200 and deposits at least a portion of the removed unprocessed material 202 in the second grinder element 118, the user disposing the second grinder element 118 upon the first grinder element 216 to grind the removed unprocessed material 202 into ground material, the user using the external depression 112 of the lid 108 to measure a predetermined quantity of the ground material, the user storing any additional ground material with the second grinder element 118 within the housing 102.

Changes may be made in the above methods, systems and structures without departing from the scope hereof. It should thus be noted that the matter contained in the above description and/or shown in the accompanying drawings should be interpreted as illustrative and not in a limiting sense. Indeed, many other embodiments are feasible and possible, as will be evident to one of ordinary skill in the art. The claims that follow are not limited by or to the embodiments discussed herein, but are limited solely by their terms and the Doctrine of Equivalents.

What is claimed:

1. A utility container with grinder, comprising:
a housing providing an at least one internal storage area proximate to a first end;
a grinder proximate to a second end opposite from the first end, the grinder having a removable grinder cap;
an internal separator separating the at least one internal storage area from the grinder; and
the first end further having a lid structured and arranged to temporarily seal the internal unprocessed material storage area, the lid having an external depression structured and arranged to hold a known volume of ground material, the removable grinder cap structured and arranged to be disposed within the housing below the lid.

2. The utility container with grinder of claim 1, wherein the internal storage area is water tight with the lid disposed to seal the inner storage area.

3. The utility container with grinder of claim 1, wherein the lid is structured and arranged to provide a child resistant locking closure for the inner storage area.

4. The utility container with grinder of claim 1, wherein the lid is a child resistant lid.

5. The utility container with grinder of claim 1, wherein the grinder cap is structured and arranged for hand rotation.

6. The utility container with grinder of claim 1, wherein the lid is hingidly attached to the housing.

7. The utility container with grinder of claim 1, wherein the lid has a circumferential ridge extending towards the internal storage area, the circumferential ridge having a binder structured and arranged to bind with an inner portion of the housing proximate to the first end.

8. The utility container with grinder of claim 7, wherein the circumferential ridge has a distal edge, a tapered groove extending from the distal end towards the lid, the tapered groove structured and arranged to strip material from a plant stalk as pulled through the tapered groove.

9. The utility container with grinder of claim 1, wherein the grinder cap has a circumferential wall and a tapered side aperture disposed in the circumferential wall, the tapered side aperture structured and arranged to strip material from a plant stalk as pulled through the tapered side aperture.

10. The utility container with grinder of claim 1, wherein the grinder cap has a circumferential wall having a distal edge, a cutter groove disposed within the circumferential wall extending downward from the distal edge.

11. The utility container with grinder of claim 9, wherein the tapered side aperture has a cutter element structured and arranged to cut paper.

12. A utility container with grinder, comprising:
a housing providing an at least one internal storage area proximate to a first end;
a lid structured and arranged to temporarily seal the at least one internal storage area, the lid having an external depression structured and arranged to hold a known volume of ground material;
a first grinder element proximate to a second end opposite from the first end, the first grinder element providing first grinding structures extending from the second end;
a second grinder element providing second grinding structures encircled by a circumferential wall, the second grinder element structured and arranged to in a first instance nest within the at least one internal storage area adjacent to the lid, and in a second instance to removably engage with the first grinder element for the grinding of unprocessed material placed therebetween; and
an internal separator separating the at least one internal storage area from the first grinder element.

13. The utility container with grinder of claim 12, wherein the lid is hingidly attached to the housing.

14. The utility container with grinder of claim 12, wherein the lid is a child resistant lid.

15. The utility container with grinder of claim 12, wherein the first grinder element and the second grinder element collectively provide a burr grinder.

16. The utility container with grinder of claim 12, wherein the lid has a circumferential ridge extending towards the internal storage area, the circumferential ridge having a binder structured and arranged to bind with an inner portion of the housing proximate to the first end.

17. The utility container with grinder of claim 12, wherein the circumferential wall of the second grinder element has a tapered side aperture disposed in the circumferential wall, the tapered side aperture structured and arranged to strip material from a plant stalk as pulled through the tapered side aperture.

18. The utility container with grinder of claim 12, wherein the circumferential wall of the second grinder element has a distal edge, a cutter groove disposed within the circumferential wall extending downward from the distal edge.

19. A method of using a utility container with grinder, comprising:
providing a housing providing an at least one internal storage area proximate to a first end;
providing a lid structured and arranged to temporarily seal the at least one internal storage area, the lid having an external depression structured and arranged to hold a known volume of ground material;
providing a first grinder element proximate to a second end opposite from the first end, the first grinder element providing grinding elements generally normal to the second end;
providing a second grinder element providing second grinding structures encircled by a circumferential wall, the second grinder element structured and arranged to in a first instance nest within the at least one internal storage area adjacent to the lid, and in a second instance to removably engage with the first grinder element for the grinding of unprocessed material placed therebetween;
providing an internal separator separating the at least one internal storage area from the first grinder element; and
wherein a user removes unprocessed material from the at least one internal storage area and deposits at least a portion of the removed unprocessed material in the second grinder element, the user disposing the second grinder element upon the first grinder element to grind the removed unprocessed material into ground material, the user using the external depression of the lid to measure a predetermined quantity of the ground material, the user storing any additional ground material with the second grinder element within the housing.

20. The method of claim 19, wherein the lid is hingidly attached to the housing.

21. The method of claim 19, wherein the lid is a child resistant lid.

22. The method of claim 19, wherein the first grinder element and the second grinder element collectively provide a burr grinder.

23. The method of claim 19, wherein the lid has a circumferential ridge extending towards the internal storage area, the circumferential ridge having a binder structured and arranged to bind with an inner portion of the housing proximate to the first end.

24. The method of claim 19, wherein the circumferential wall of the second grinder element has a tapered side aperture disposed in the circumferential wall, the tapered side aperture structured and arranged to strip material from a plant stalk as pulled through the tapered side aperture.

25. The method of claim 19, wherein the circumferential wall of the second grinder element has a distal edge, a cutter groove disposed within the circumferential wall extending downward from the distal edge.
